(19) United States
(12) Patent Application Publication
(10) Pub. No.: US 2026/0065800 A1
(43) Pub. Date: Mar. 5, 2026

(54) COCKPIT REPLICA BASED ON VIRTUAL REALITY

(71) Applicant: Loft Dynamics AG., Dübendorf (CH)

(72) Inventors: Simon Kassian Locher, Dübendorf (CH); Christian Marty, Dübendorf (CH)

(21) Appl. No.: 18/819,513

(22) Filed: Aug. 29, 2024

(51) Int. Cl. G09B 9/30; G09B 9/12

(52) U.S. Cl. CPC G09B 9/307; G09B 9/12; G09B 9/302

(57) ABSTRACT

VR cockpit replication includes sensing a physical position of a user in a flight simulator with at least one pose tracking sensor. The flight simulator has a physical replication of a cockpit with interactable hardware. The sensed physical position of the user is displayed in a virtual replication of the cockpit using a head-mounted display (HMD) device wearable by the user in the flight simulator. The VR cockpit replication may provide synchronization of haptic and visual feedback between a physical interaction of the user and the interactable hardware with the sensed physical position of the user displayed in the virtual replication of the cockpit.

### FIELD OF THE DISCLOSURE

The present disclosure relates to aircraft simulation systems. The disclosure has particular utility in aircraft simulation systems which use a virtual reality (VR) cockpit replica and manage haptic and visual feedback between physical components and virtual components, and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Flight simulation is used to artificially generate aircraft flight and an environment in which the aircraft flies, for pilot training, design, or other purposes. Flight simulators typically virtually recreate situations of aircraft flight, including how aircraft react to applications of flight controls, the effects of other aircraft systems, and how the aircraft reacts to external factors such as air density, turbulence, wind shear, clouds, precipitation, etc. Flight simulation is used for a variety of reasons, including flight training pilots, the design and development of the aircraft itself, and research into aircraft characteristics and control handling qualities. Some simulations are based on previously recorded flights which are virtually recreated for a pilot.

While flight simulators have conventionally used large projection displays which virtually recreate the environment outside of the aircraft, modern flight simulators often use a head-mounted display (HMD) device. HMD devices are visual display devices worn by the user on his or her head, or as part of a helmet, where a small display is provided to the line of sight of the user alone. VR headsets are a type of HMD device that track 3D position and rotation to provide a virtual environment to the user. As such, the use of VR HMD devices enables more precise visual depictions of the environment from the user's subjective perspective, which provides a more accurate simulation.

To be effective, a VR cockpit simulator needs to correctly respond to accurately perceived human inputs without delays, a problem that requires robust pose estimation and rapid rendering in an imperceptible response time. VR cockpits for pilot training must display the life-sized control panels and other instrumentation which exists in a physical cockpit, despite the fact that these panels and instrumentation often have tiny keys and dials which are difficult to accurately construct in a digital environment. This necessitates exceptional pose tracking accuracy with low system latency. Moreover, simulation cockpits are mounted to a moving platform which actuates during simulation. In order for a VR cockpit simulator to function properly, it requires exceptional pose tracking accuracy (<10 mm), and undetectable lag, low system latency (<60 ms), and rapid rendering. This is a challenge to achieve in a fully static setting, and more so simultaneously on a moving platform.

To improve over these limitations of conventional simulation systems, the present disclosure is directed to a VR cockpit replication system and method which provides synchronization of haptic and visual feedback in a VR flight simulator. The system may include the use of one or more pose tracking sensors positioned to sense the body of a user within a flight simulator, where the user is wearing an HMD device that provides a visual display of the flight simulation. Measurement data of the body position or movement of the user is captured with the pose tracking sensors, which is used to make a 3D reconstruction of the user. In particular, the position of the user's body may be determined relative to interactive, physical hardware components within the flight simulator. The 3D reconstruction is displayed on the HMD device with the flight simulation, and user haptic feedback from interaction with physical hardware is accurately aligned with the perceived VR visualization of user's body relative to physical hardware position.

Accurate portrayal of the user's body position relative to physical components of the simulator cockpit allows one to accurately gauge the position of his or her body relative to the physical hardware all while maintaining uninterrupted use of the VR HMD device. For instance, while a user is visually viewing the flight simulation on the HMD device, he or she can accurately judge or gauge the distance of the user's hand relative to a button, switch, lever, or other hardware component of the physical simulation environment. This ability to accurately portray physical interactions between users and hardware components within a VR flight simulation is important for the user to accurately and realistically pilot the simulated aircraft and respond to the simulation state. Millimeter-level accuracy allows a user to receive synchronized haptic and visual feedback of interacting with multiple hardware components that the user is not constantly in contact with.

In one embodiment, a VR cockpit replication system includes a flight simulator having a physical replication of a cockpit with interactable hardware. An HMD device is wearable by a user in the flight simulator. The HMD device is configured to display a virtual replication of the cockpit. At least one pose tracking sensor senses a physical position of the user. The sensed physical position of the user is displayed in the virtual replication of the cockpit in the HMD device.

In one aspect, the sensed physical position of the user is displayed in an avatar of the user within the virtual replication of the cockpit in the HMD device.

In another aspect, the sensed physical position of the user is determined relative to the interactable hardware.

In yet another aspect, the sensed physical position of the user further comprises motion of the user.

In another aspect, the at least one pose tracking sensor further comprises at least two pose tracking sensors positioned in different locations within the flight simulator.

In yet another aspect, the at least one pose tracking sensor further comprises at least one of: a pose tracking camera, an ultrasonic sensor, a near-field sensing camera, a radar sensor, an in-air haptics sensor, or a lighthouse positioning system.

In another aspect, the at least one pose tracking sensor is mounted in the flight simulator with at least one mount, wherein the mount absorbs vibrations.

In another embodiment, a method of VR cockpit replication includes sensing a physical position of a user in a flight simulator with at least one pose tracking sensor, wherein the flight simulator has a physical replication of a cockpit with interactable hardware. The sensed physical position of the user is displayed in a virtual replication of the cockpit using an HMD device wearable by the user in the flight simulator.

In one aspect, the physical position of the user in the flight simulator is determined relative to the interactable hardware.

In another aspect, displaying the sensed physical position further comprises displaying an avatar of the user within the virtual replication of the cockpit in the HMD device.

In yet another aspect, sensing the physical position of the user further comprises sensing motion of the user.

In another aspect, sensing the physical position of the user further comprises sensing the physical position of the user using at least two pose tracking sensors positioned at different locations within the flight simulator.

In yet another aspect, sensing the physical position of the user in the flight simulator further comprises at least one of: sensing the physical position of hands of the user; or using convolutional neural nets to detect a position of body parts of the user.

In another aspect, displaying the sensed physical position of the user in the virtual replication of the cockpit synchronizes haptic and visual feedback between a physical interaction of the user and the interactable hardware with the sensed physical position of the user displayed in the virtual replication of the cockpit.

In yet another aspect, the method further comprises obtaining raw measurement data of the sensed physical position of the user from at least two pose tracking sensors and, using a 3D reconstruction system, combining the raw measurement data to form a 3D representation of a body of the user and correlating the 3D representation of the body of the user with a position and orientation of the HMD device.

In another aspect, the at least one pose tracking sensor further comprises at least one of: a pose tracking camera, an ultrasonic sensor, a near-field sensing camera, a radar sensor, an in-air haptics sensor, or a lighthouse positioning system.

In another embodiment, a method of synchronizing haptic and visual feedback in a VR flight simulator is disclosed. Measurement data of a physical position of a user in a flight simulator is sensed with at least two pose tracking sensors located in different positions. A 3D representation of a body of the user is generated based on the sensed measurement data. The 3D representation of the body of the user is combined with user input data derived from interactable hardware in the flight simulator. In an HMD device worn by the user, a simulated environment is displayed with a VR visualization of the 3D representation of the body of the user, thereby accurately displaying physical positions of the body of the user relative to the interactable hardware in the VR visualization.

In one aspect, sensing measurement data of the physical position of the user in the flight simulator further comprises sensing motion of the user.

In another aspect, sensing measurement data of the physical position of the user further comprises using at least one of: a pose tracking camera, an ultrasonic sensor, a near-field sensing camera, a radar sensor, an in-air haptics sensor, or a lighthouse positioning system.

In yet another aspect, the method further comprises physically moving the flight simulator while sensing measurement data of the physical position of the user.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1A is a diagrammatic illustration of a VR cockpit replication system, in accordance with the present disclosure;

FIG. 1B is an illustration of a view of the virtual flight simulation provided by the HMD device of the VR cockpit replication system of FIG. 1A, in accordance with the present disclosure;

FIG. 2 is a diagrammatic illustration of a VR cockpit replication system, in accordance with the present disclosure;

FIG. 3 is a diagrammatic illustration of a calibrating a VR cockpit replication system, in accordance with the present disclosure;

FIG. 4 is a diagrammatic flowchart illustrating operations of the VR cockpit replication system of FIGS. 1A-3, in accordance with the present disclosure;

FIG. 5 is a flowchart illustrating a method of VR cockpit replication, in accordance with the present disclosure; and

FIG. 6 is a flowchart illustrating a method of synchronizing haptic and visual feedback in a VR flight simulator, in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure is directed to a VR cockpit replication system and method which provides benefits in synchronizing haptic and visual feedback in a VR flight simulator. The system may include the use of one or more pose tracking sensors positioned to sense the body of a user within a flight simulator, where the user is wearing an HMD device that provides a visual display of the flight simulation. Measurement data of the body position or movement of the user is captured with the pose tracking sensors, which is used to make a 3D reconstruction of the user. This positional data may include a 3D offset and a relative orientation, which may include three parameters to determine an orientation/rotation. In particular, the position of the user's body may be determined relative to interactive, physical hardware components within the flight simulator. The 3D reconstruction is displayed on the HMD device with the flight simulation, and user haptic feedback from interaction with physical hardware is accurately aligned with the perceived VR visualization of the user's body relative to physical hardware position.

Accurate portrayal of the user's body position relative to physical components of the simulator cockpit allows one to accurately gauge the position of his or her body relative to the physical hardware all while maintaining uninterrupted use of the VR HMD device. For instance, while a user is visually viewing the flight simulation on the HMD device, he or she can accurately judge or gauge the distance of the user's hand relative to a button, switch, lever, or other hardware component of the physical simulation environment. This ability to accurately portray physical interactions between users and hardware components within a VR flight simulation is important for the user to accurately and realistically pilot the simulated aircraft and respond to the simulation state. Millimeter-level accuracy allows a user to receive synchronized haptic and visual feedback of interacting with multiple hardware components that the user is not constantly in contact with. Realism is especially important for regulatory certification of the simulator.

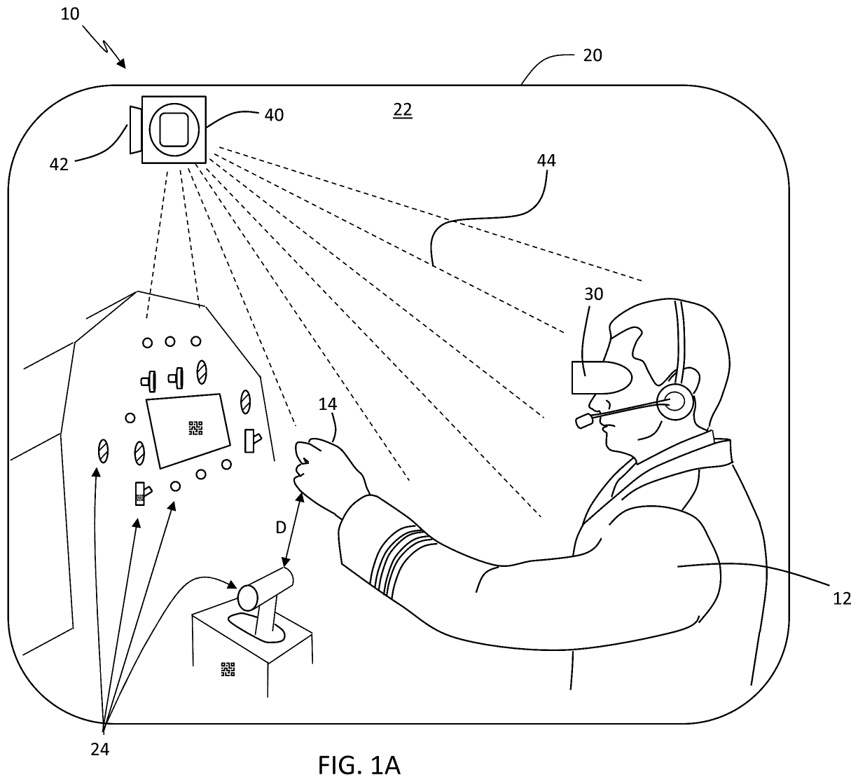

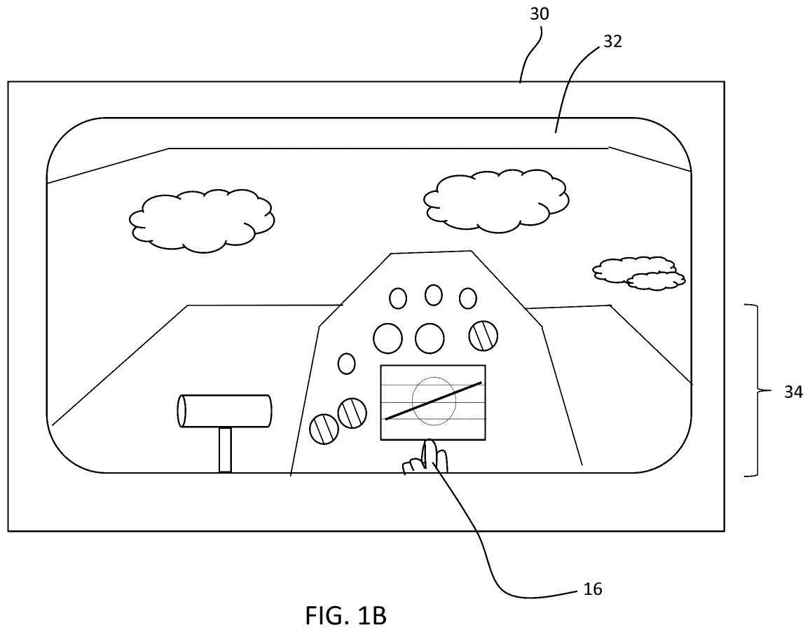

FIG. 1A is a diagrammatic illustration of a VR cockpit replication system 10, in accordance with the present disclosure. The VR cockpit replication system 10, which may be referred to as ‘system 10’ includes a flight simulator 20 or simulator platform having a physical replication of a cockpit 22 with interactable hardware 24. The physical replication of the cockpit 22 includes a structure which replicates portions of an aircraft cockpit, such that a user 12 of the flight simulator 20 can be seated and have access to the physical interactable hardware 24 that is used in operational aircraft. Interactable hardware 24 may include, for example, buttons, switches, flight joysticks, levers, or any other physical components which are typical of aircraft cockpits. These interactable hardware 24 components may be used to simulate flight controls of an aircraft. During simulation, user interaction with these interactable hardware 24 devices is detected and the interaction itself, and/or an effect of that interaction on the simulated flight, is provided to a visual display for the user 12. The flight simulator 20 may include any features or functions which are used in simulation systems, such as moving platforms, haptic feedback from interactable hardware 24 or non-interactable hardware, auditory feedback, or any others.

User 12 may wear an HMD device 30 while in the flight simulator 20, which provides the user with the ability to see the virtual flight simulation. HMD device 30 may include any type of display device which is wearable by user 12 or otherwise positioned in a field of view of user 12. For instance, HMD device 30 may include glasses or goggles which are worn by user 12, or a helmet-mounted device, or similar devices. FIG. 1A illustrates the HMD device 30 worn by user 12 and FIG. 1B is an illustration of the visual display 32 which the user 12 sees in the virtual flight simulation provided by the HMD device 30. HMD device 30 displays the virtual replication of the cockpit 34, which is designed to visually resemble a real flight cockpit while mirroring or closely matching the physical control elements of the cockpit 22 of flight simulator 20 in which user 12 is located. In this way, any physical interaction that user 12 has with the physical replication of cockpit 22 can be digitally replicated in the virtual replication of the cockpit 34 and displayed to user 12 via HMD device 30.

Additionally, the visual display 32 on HMD device 30 includes VR replication of the user 12, or more often, a portion of the user's 12 body. For example, the visual display 32 may depict an avatar of user 12, or a portion thereof, which is depicted to represent or match the sensed physical position of user 12 in the physical replication of the cockpit 22. This allows the sensed physical position of user 12 to be displayed in the virtual replication of the cockpit 34 in the HMD device 30, such that the user can perceive the location of their body in physical space based on the depicted location in the visual display 32. In FIG. 1B, this depiction on visual display 32 includes a virtual hand 16 which matches the position of hand 14 in FIG. 1A. Other parts of the user's 12 body may be depicted as well, such as arms, feet, legs, etc.

As is also shown in FIG. 1B, in addition to user 12 viewing the virtual replication of the cockpit 34 and the virtual depiction of their body, the virtual flight simulation may display other components of the simulation, such as a replicated outside view from the cockpit where terrain, objects, weather conditions, or environmental parameters are displayed. The virtual replication of the cockpit 34 may also include features which are part of a training exercise or a simulated environment, e.g., a co-pilot, smoke from a fire, etc.

With reference to FIGS. 1A-1B together, at least one pose tracking sensor 40 is used to sense a physical position of user 12. Commonly, the pose tracking sensor 40 is positioned within the physical replication of the cockpit 22, such that it can sense all or a portion of the interior space of the physical replication of the cockpit 22. The pose tracking sensor 40 may be mounted in the flight simulator 20 with at least one mount 42 which absorbs vibrations and unwanted movement transferred to the pose tracking sensor 40. This minimizes the shifting and vibration of the pose tracking sensor 40 during simulation, especially when the flight simulator 20 includes a movable platform which causes the physical replication of the cockpit 22 to be moved. The mount 42 may include any type of structure which is capable of retaining the pose tracking sensor 40 in the desired position yet absorb, partially or fully, unwanted vibrations and movements.

In use, the pose tracking sensor 40 may emit one or more signals 44 into the physical replication of the cockpit 22, where the signal 44 detects a position or movement of objects in the physical replication of the cockpit 22, for example, the user 12, HMD device 30 worn by user 12, and/or interactable hardware 24 components in the physical replication of the cockpit 22. The signal 44 may be sensed by the pose tracking sensor 40 to generate raw measurement data of the objects in the physical replication of the cockpit 22. This measurement data may include, for instance, measurement data of the body of the user 12, and often a particular portion of the user's 12 body, such as a hand 14 which is commonly used to interact with interactable hardware 24 components. The measurement data may also indicate a location, orientation, position, or pose of the HMD device 30, which can be used to indicate a direction of gaze of user 12. A position of the interactable hardware 24 can also be sensed, such as whether a switch is actuated, a position of a joystick, engine control handle, or yoke, etc.

The system 10 may sense a physical position of user 12 relative to interactable hardware 24. As such, it may be possible to determine the distance between any two objects within the physical replication of the cockpit 22, such as, for instance, the distance between the user 12 and the interactable hardware 24. This allows system 10 to correlate interactions between movements of different objects. As an example, in FIG. 1A, pose tracking sensor 40 may determine that the distance, D, between the hand 14 of user 12 and the engine control handle. If distance D is determined to increase, system 10 can correlate that change in distance to the user 12 moving his or her hand 14 further away from the engine control handle.

It is noted that the signal 44 used to capture measurement data of objects can be emitted continuously over a period of time, such as the duration of the flight simulation, to capture positional data over that period of time. This data may be analyzed to determine a change in position between two time periods to indicate motion of user 12, or motion of another object, irrespective of a distance between two objects. For example, system 10 can continuously determine where the user's 12 head is turned to determine a direction the user 12 is facing, which can be used to determine a direction of gaze of the HMD device 30. Motion data can also be used in conjunction with the distance between objects. For instance, if system 10 determines that the hand 14 of user 12 is moving in a rotational manner and is in contact with a dial, e.g. D equals zero, it can be determined that the user 12 is rotating the dial.

The pose tracking sensor 40 may include various types of sensors or combinations thereof. These may include, for instance, a pose tracking camera which visually determines a position or pose of an object, an ultrasonic sensor which determines a position of an object using acoustics, a near-field sensing camera which determines positional information of an object by detecting changes in acoustics, light, or other parameters, a radar sensor using analysis of reflected electromagnetic waves, an in-air haptics sensor using ultrasonic waves, a lighthouse positioning system using optical data, or others.

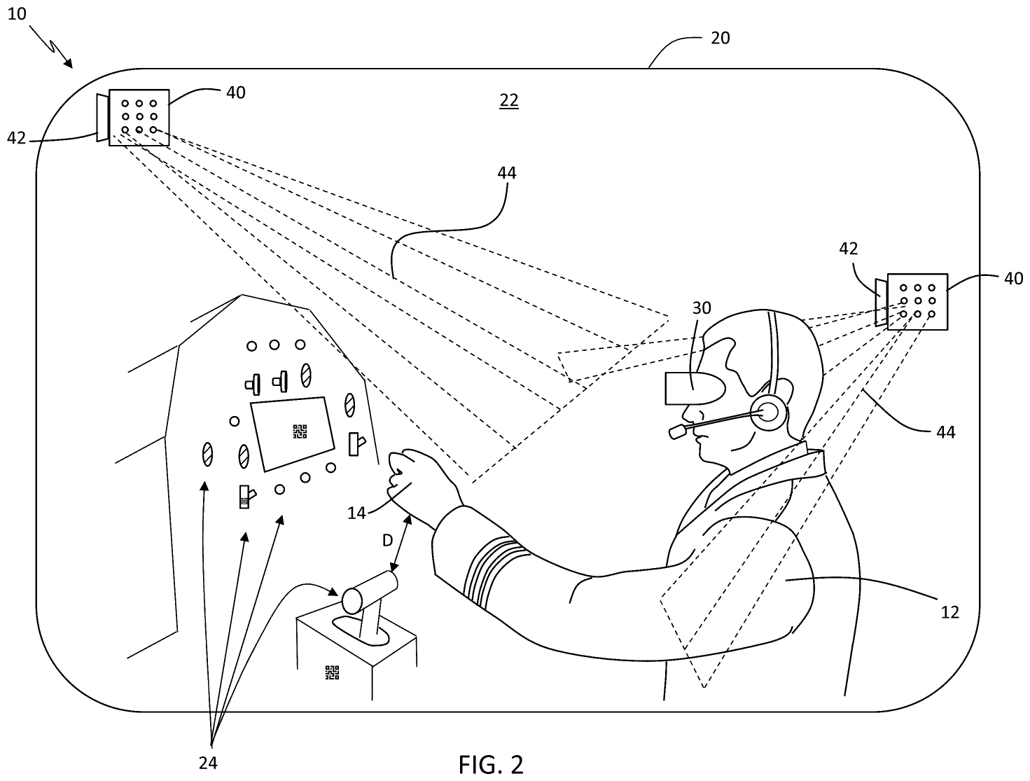

It may be common for more than one pose tracking sensor 40 to be used. FIG. 2 is a diagrammatic illustration of the VR cockpit replication system 10 which has a plurality of pose tracking sensors. In this example, the pose tracking sensors 40 are depicted as a lighthouse positioning system with at least two sensors 40 that are positioned in different locations within the flight simulator 20 to gain optically-sensed data from multiple angles. Here, the use of different detection angles for the pose tracking sensors 40 helps ensure full coverage of the physical replication of the cockpit 22, including all sides of the user 12 and objects within the physical replication of the cockpit 22. Any number of pose tracking sensors 40 may be used with the system 10, and exemplary implementations may include multiple pose tracking sensors 40 to ensure robust capture of positional information of user 12 and/or interactable hardware 24.

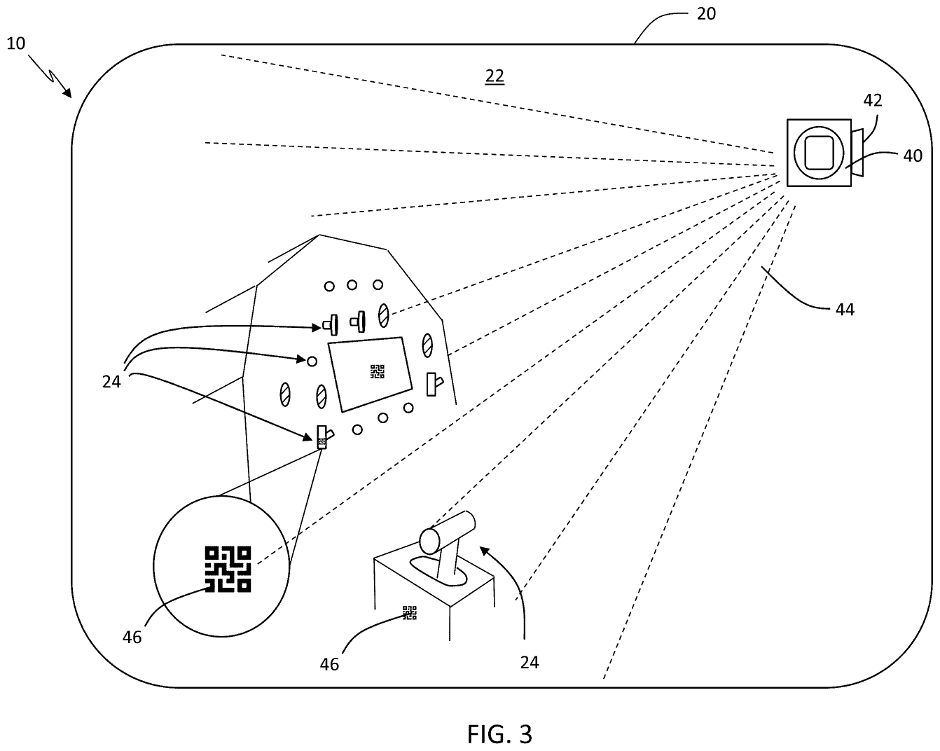

Before a simulation begins, calibration of the pose tracking sensor 40 may be required. FIG. 3 is a diagrammatic illustration of a calibrating the system 10, where pose tracking sensor 40 within replication of the cockpit 22 of the flight simulator 20 emits one or more signals 44 to hardware components 24 to calibrate the distance and relative orientation between the pose tracking sensor 40 and the interactable hardware 24. In one example, calibration of the pose tracking sensor 40 uses one or more fiducial markers 46 or codes, which may be similar to QR codes, that can be sensed by the pose tracking sensor 40. For instance, a reflected signal received by pose tracking sensor 40 may be able to identify the particular interactable hardware 24 component to which the fiducial marker 46 is keyed to, such that system 10 can determine the interactable hardware 24 component type or identity, and its position prior to simulation.

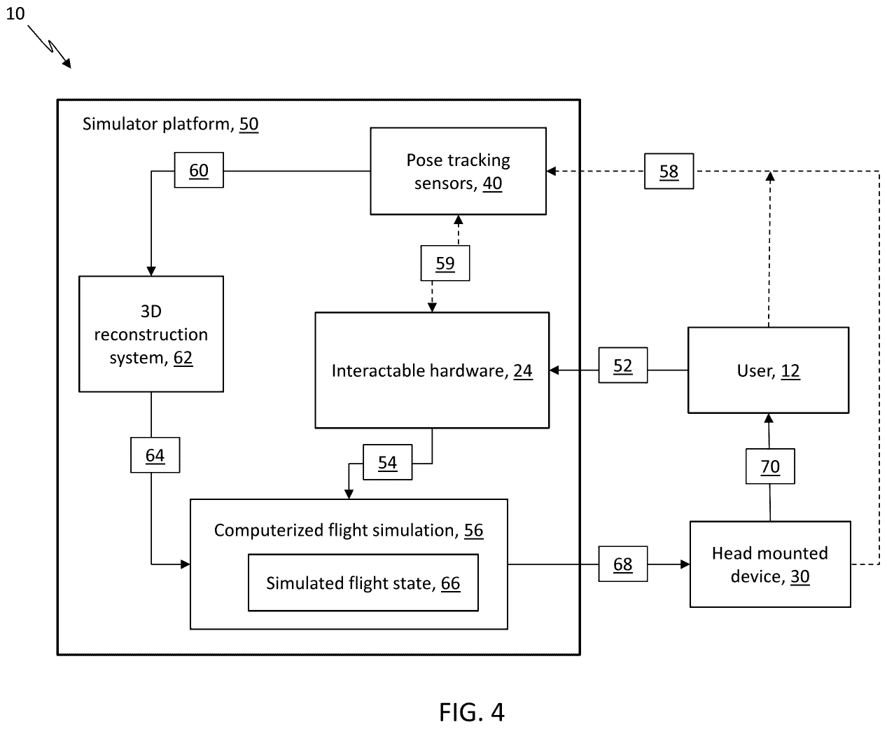

FIG. 4 is a diagrammatic flowchart illustrating operations of a simulator platform 50 used by the VR cockpit replication system 10 of FIGS. 1A-3, in accordance with the present disclosure. During a simulation, user's 12 physical interaction with the interactable hardware 24 may cause intermittent user inputs 52 to the interactable hardware 24 components that represent flight input data 54 to the computerized flight simulation 56. This may include any type of interaction with the interactable hardware 24, such as actuating switches, moving control devices, etc. This physical interaction may be correlated with the particular events in the simulation, such as changing the simulated flap settings only during landing. During simulation, the pose tracking sensors 40 take raw measurements 58 of the user body parts and of the HMD device 30. These raw measurements 58 may be taken from multiple angles to improve accuracy of object detection. For instance, in one example, these raw measurements may include higher fidelity measurements of the user's hands 14 (FIGS. 1A, 2). In another example, these raw measurements 58 may include using convolutional neural nets and the OPENPOSE™ software to detect the body parts of user 12. As discussed relative to FIG. 3, the system 10 may calibrate the pose tracking sensors 40 relative to the interactable hardware 24 components to determine a calibrated distance 59 between the pose tracking sensors 40 and the interactable hardware 24 components.

The raw measurements 58 obtained by sensors is output as raw sensor data 60 from pose tracking sensors 40 to a 3D reconstruction system 62. The 3D reconstruction system 62 which combines the 2D measurements of the raw sensor data 60 from the pose tracking sensors 40 into pose measurement data 64 that is a 3D representation of the user's 12 body and HMD device 30 position and orientation accurately measured relative to the interactable hardware 24 components. This pose measurement data 64 is used by the computerized flight simulation 56 that is recording and simulating a simulated flight state 66. The pose measurement data 64 is combined with the flight input data 54 derived from interactable hardware 24 components to generate the flight visualization data 68 displayed on the HMD device 30. The flight visualization data 68 displayed on the HMD device 30 provides the user 12 an accurate flight, cockpit, and body visualization 70, that allows the user 12 to accurately provide further inputs to the interactable hardware 24 components during the simulation.

The 3D representation of the user's 12 body and the HMD device 30 may be highly accurate. In one example, the accuracy is to within 10 mm, although other accuracies may be achieved. To accurately simulate a real flight cockpit, the user 12 must perceive the interactable hardware 24 component through their HMD device 30 in the same physical position it is on the simulator platform 50 or in a physical position whose error is below the threshold of human detectability. The system 10 also provides simulation with low latency, thus providing a responsive simulation environment to haptic feedback, including feedback generated from a moving simulator platform. Accordingly, highly accurate 3D virtual representations of the underlying sensed physical data may be important to ensure a precise simulation experience.

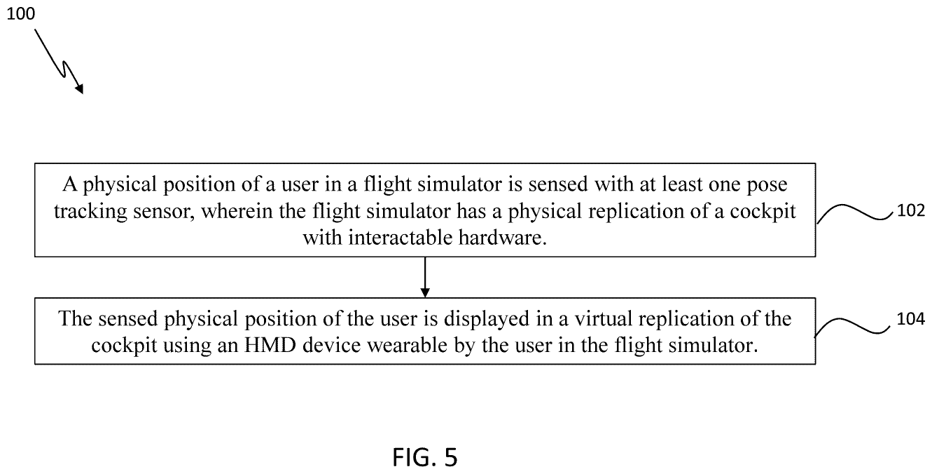

FIG. 5 is a flowchart 100 illustrating a method of VR cockpit replication, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As shown at block 102, a physical position of a user in a flight simulator is sensed with at least one pose tracking sensor, wherein the flight simulator has a physical replication of a cockpit with interactable hardware. The sensed physical position of the user is displayed in a virtual replication of the cockpit using an HMD device wearable by the user in the flight simulator (block 104). Any number of additional steps, functions, processes, or variants thereof may be included in the method, including any disclosed relative to any other figure of this disclosure.

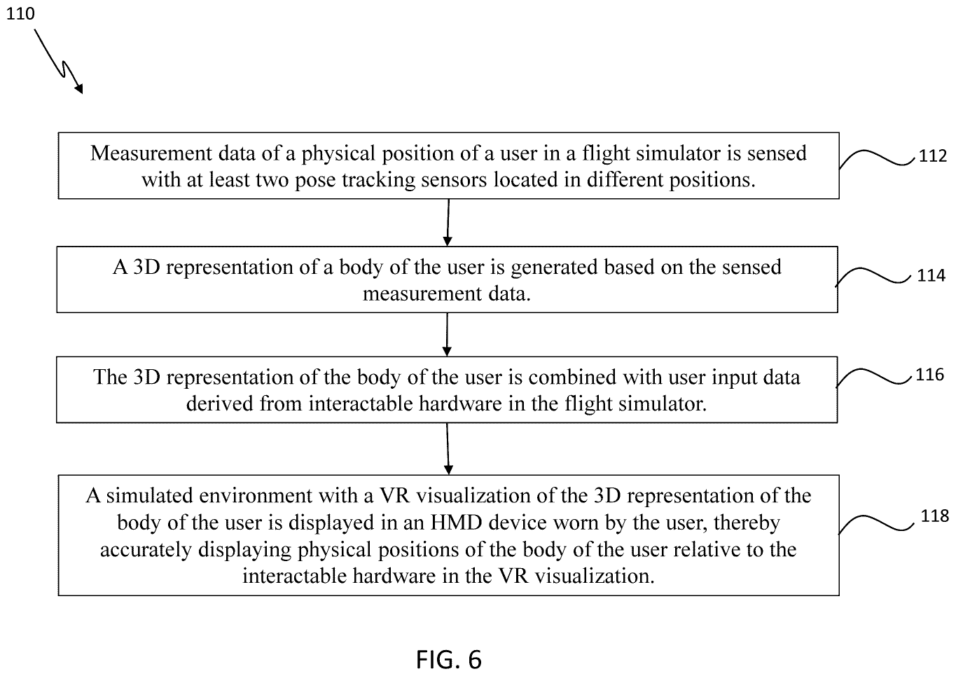

FIG. 6 is a flowchart 110 illustrating a method of synchronizing haptic and visual feedback in a VR flight simulator, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As shown by block 112, measurement data of a physical position of a user in a flight simulator is sensed with at least two pose tracking sensors located in different positions. A 3D representation of a body of the user is generated based on the sensed measurement data (block 114). The 3D representation of the body of the user is combined with user input data derived from interactable hardware in the flight simulator (block 116). A simulated environment with a VR visualization of the 3D representation of the body of the user is displayed in an HMD device worn by the user, thereby accurately displaying physical positions of the body of the user relative to the interactable hardware in the VR visualization (block 118). Any number of additional steps, functions, processes, or variants thereof may be included in the method, including any disclosed relative to any other figure of this disclosure.

It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

The foregoing description of the embodiments has been provided for purposes of illustration and description. It is not intended to be exhaustive or to limit the disclosure.

Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

10 virtual reality (VR) cockpit replication system
12 user
14 hand
16 virtual hand
20 flight simulator
22 physical replication of a cockpit
24 interactable hardware
30 head-mounted display (HMD) device
32 visual display
34 virtual replication of the cockpit
40 pose tracking sensor
42 mount
44 signal
46 fiducial markers
50 simulator platform
52 user inputs
54 flight input data
56 computerized flight simulation
58 raw measurements
59 calibrated distance
60 raw sensor data
62 3D reconstruction system
64 pose measurement data
66 simulated flight state
68 flight visualization data
70 flight, cockpit, and body visualization

What is claimed is:

1. A virtual reality (VR) cockpit replication system comprising:
a flight simulator having a physical replication of a cockpit with interactable hardware;
a head-mounted display (HMD) device wearable by a user in the flight simulator, the HMD device configured to display a virtual replication of the cockpit; and
at least one pose tracking sensor sensing a physical position of the user, wherein the sensed physical position of the user is displayed in the virtual replication of the cockpit in the HMD device.

2. The VR cockpit replication system of claim 1, wherein the sensed physical position of the user is displayed in an avatar of the user within the virtual replication of the cockpit in the HMD device.

3. The VR cockpit replication system of claim 1, wherein the sensed physical position of the user is determined relative to the interactable hardware.

4. The VR cockpit replication system of claim 1, wherein the sensed physical position of the user further comprises motion of the user.

5. The VR cockpit replication system of claim 1, wherein the at least one pose tracking sensor further comprises at least two pose tracking sensors positioned in different locations within the flight simulator.

6. The VR cockpit replication system of claim 1, wherein the at least one pose tracking sensor further comprises at least one of: a pose tracking camera, an ultrasonic sensor, a near-field sensing camera, a radar sensor, an in-air haptics sensor, or a lighthouse positioning system.

7. The VR cockpit replication system of claim 1, wherein the at least one pose tracking sensor is mounted in the flight simulator with at least one mount, wherein the mount absorbs vibrations.

8. A method of virtual reality (VR) cockpit replication comprising:
sensing a physical position of a user in a flight simulator with at least one pose tracking sensor, wherein the flight simulator has a physical replication of a cockpit with interactable hardware; and
displaying the sensed physical position of the user in a virtual replication of the cockpit using a head-mounted display (HMD) device wearable by the user in the flight simulator.

9. The method of claim 8, wherein the physical position of the user in the flight simulator is determined relative to the interactable hardware.

10. The method of claim 8, wherein displaying the sensed physical position further comprises displaying an avatar of the user within the virtual replication of the cockpit in the HMD device.

11. The method of claim 8, wherein sensing the physical position of the user further comprises sensing motion of the user.

12. The method of claim 8, wherein sensing the physical position of the user further comprises sensing the physical position of the user using at least two pose tracking sensors positioned at different locations within the flight simulator.

13. The method of claim 8, wherein sensing the physical position of the user in the flight simulator further comprises at least one of: sensing the physical position of hands of the user; or using convolutional neural nets to detect a position of body parts of the user.

14. The method of claim 8, wherein displaying the sensed physical position of the user in the virtual replication of the cockpit synchronizes haptic and visual feedback between a physical interaction of the user and the interactable hardware with the sensed physical position of the user displayed in the virtual replication of the cockpit.

15. The method of claim 8, further comprising:
obtaining raw measurement data of the sensed physical position of the user from at least two pose tracking sensors; and
in a 3D reconstruction system, combining the raw measurement data to form a 3D representation of a body of the user and correlating the 3D representation of the body of the user with a position and orientation of the HMD device.

16. The method of claim 8, wherein the at least one pose tracking sensor further comprises at least one of: a pose tracking camera, an ultrasonic sensor, a near-field sensing camera, a radar sensor, an in-air haptics sensor, or a lighthouse positioning system.

17. A method of synchronizing haptic and visual feedback in a virtual reality (VR) flight simulator, comprising:
sensing measurement data of a physical position of a user in a flight simulator with at least two pose tracking sensors located in different positions;
generating a 3D representation of a body of the user based on the sensed measurement data;
combining the 3D representation of the body of the user with user input data derived from interactable hardware in the flight simulator; and
displaying, in a head-mounted display (HMD) device worn by the user, a simulated environment with a VR visualization of the 3D representation of the body of the user, thereby accurately displaying physical positions of the body of the user relative to the interactable hardware in the VR visualization.

18. The method of claim 17, wherein sensing measurement data of the physical position of the user in the flight simulator further comprises sensing motion of the user.

19. The method of claim 17, wherein sensing measurement data of the physical position of the user further comprises using at least one of: a pose tracking camera, an ultrasonic sensor, a near-field sensing camera, a radar sensor, an in-air haptics sensor, or a lighthouse positioning system.

20. The method of claim 17, further comprising physically moving the flight simulator while sensing measurement data of the physical position the user.
